(19) United States
(12) Patent Application Publication
(10) Pub. No.: US 2018/0214719 A1
(43) Pub. Date: Aug. 2, 2018

(54) PROTECTIVE INTERFACES FOR FIREFIGHTER GARMENTS

(71) Applicant: INNOTEX INC., Richmond (CA)

(72) Inventor: Claude Barbeau, St-Bruno (Quebec) (CA)

(21) Appl. No.: 15/886,453

(22) Filed: Feb. 1, 2018

Related U.S. Application Data
(60) Provisional application No. 62/453,771, filed on Feb. 2, 2017.

(51) Int. Cl. A62B 17/00; B32B 33/00; B32B 5/02; B32B 27/12; B32B 27/08; B32B 27/32; B32B 27/34

(52) U.S. Cl. CPC A62B 17/003; B32B 33/00; B32B 5/026; B32B 27/12; B32B 27/08; B32B 2307/724; B32B 27/34; B32B 2262/0269; B32B 2307/3065; B32B 2437/00; B32B 27/322

(57) ABSTRACT

A firefighter protective garment is provided. The garment includes an inner liner, an outer shell and a protective interface. The outer shell is made of a flame-retardant material and extends over at least a portion of the inner liner. The protective interface joins the inner liner and outer shell along at least one extremity of the garment. The protective interface is made of an interface material having particulate-impermeable and air-permeable properties.

### TECHNICAL FIELD

The technical field generally relates to protective garments for firefighters and more particularly concerns protective interfaces for such garments.

### BACKGROUND

Firefighter garments, such as coats and pants, have designs which are required to be compliant with the National Fire Protection Association Standard on Protective Ensembles for Structural Fire Fighting and Proximity Fire Fighting.

A typical firefighter coat usually includes an outer protective shell made of a fire-resistant material such as a fabric of aramid fibers (sold under the trademark NOMEX), and a liner including a moisture barrier and a thermal barrier.

In firefighter coats, to protect the firefighter from the ingress of fire-ground liquids and particulate matter between the liner and outer shell or between the liner and the body of the firefighter, it is known to incorporate sleeve wells on the lower sleeve ends of the coat. The sleeve wells, also referred to in the art as water wells, are folds of waterproof fabric extending within the lower end of the sleeves and connected to both the outer shell and to wristlets designed to fit around the wrists of the firefighter. The sleeve wells therefore typically ensure that liquids and particulate matter cannot penetrate the coat.

These sleeve wells may be constructed of totally impermeable barrier materials such a neoprene-coated fabric in which case no particulate matter, liquids, vapors or gases can penetrate the lower sleeve ends. Similarly, the sleeve wells may also be constructed of fabrics laminated to a semi-permeable membrane such as expanded polytetrafluoroethylene (ePTFE). Conversely, the wristlets of the sleeve ends, which are usually constructed of extensible, knit fabric, are very permeable to particulates, air and to liquids.

Firefighter pants also include an outer protective shell and an inner liner of similar construction than the corresponding layers of firefighter coats. At the bottom of each pants leg, it is known to incorporate a gaiter bridging the gap between the bottom of the pant leg and the firefighter boot, again preventing liquid and particulate matter to penetrate inside the garment.

There remains a need in the art for interfaces of firefighter garments that improve on the security and/or comfort of the wearer.

### SUMMARY

Protective interfaces for firefighter garments are described herein.

In accordance with an aspect, there is provided a firefighter protective garment including:
an inner liner;
an outer shell made of a flame-retardant material, the outer shell extending over at least a portion of the inner liner; and
a protective interface joining the inner liner and outer shell along at least one extremity of the garment, the protective interface being made of an interface material having particulate-impermeable and air-permeable properties.

In some embodiments, the protective interface is permanently attached to at least one of the inner liner and the outer shell.

In some embodiments, the firefighter garment includes a fastener arrangement attaching the protective interface to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In some embodiment, the interface material is a trilaminate including:
a membrane made of expanded polytetrafluoroethylene (ePTFE);
a first aramid knit provided on a first side of the membrane; and
a second aramid knit provided on a second side of the membrane.

In some embodiments, the interface material is a trilaminate includes:
a membrane made of expanded polytetrafluoroethylene (ePTFE);
an aramid knit provided on a first side of the membrane; and
a reprocessed cellulose multifilament knit provided on a second side of the membrane.

In some embodiments, the interface material includes a meta-aramid material quilted between two aramid knits.

In accordance with another aspect, there is provided a firefighter protective coat including:
an inner liner;
an outer shell made of a flame-retardant material, the outer shell extending over at least a portion of the inner liner; and
a sleeve well joining the inner liner and outer shell along at least one extremity of the firefighter protective coat, the sleeve well being made of an interface material having particulate-impermeable and air-permeable properties.

In some embodiments, the sleeve well is permanently attached to at least one of the inner liner and the outer shell.

In some embodiments, the firefighter protective coat includes a fastener arrangement attaching the sleeve well to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In accordance with another aspect, there is provided a firefighter protective coat including:
an inner liner;
an outer shell made of a flame-retardant material, the outer shell extending over at least a portion of the inner liner; and
a wristlet joining the inner liner and outer shell along at least one extremity of the firefighter protective coat, the wristlet being made of an interface material having particulate-impermeable and air-permeable properties.

In some embodiments, the wristlet is permanently attached to at least one of the inner liner and the outer shell.

In some embodiments, the firefighter protective coat includes a fastener arrangement attaching the wristlet to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In accordance with another aspect, there is provided a firefighter protective coat including:
an inner liner;
an outer shell made of a flame-retardant material, the outer shell extending over at least a portion of the inner liner; and
a stormband joining the inner liner and outer shell along at least one extremity of the firefighter protective coat, the stormband being made of an interface material having particulate-impermeable and air-permeable properties.

In some embodiments, the stormband is permanently attached to at least one of the inner liner and the outer shell.

In some embodiments, the firefighter protective coat includes a fastener arrangement attaching the stormband to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In accordance with another aspect, there is provided a firefighter protective coat including:
an inner liner;
an outer shell made of a flame-retardant material, the outer shell extending over at least a portion of the inner liner; and
a protective interface joining the inner liner and outer shell along at least one extremity of the firefighter protective coat, the protective interface being made of an interface material having particulate-impermeable and air-permeable properties.

In some embodiments, the protective interface is permanently attached to at least one of the inner liner and the outer shell.

In some embodiments, the firefighter protective coat includes a fastener arrangement attaching the protective interface to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In some embodiments, the protective interface is a sleeve well. In some embodiments, the protective interface is a wristlet.

In some embodiments, the protective interface is a stormband.

In accordance with another aspect, there are provided firefighter protective pants including:
an inner liner;
an outer shell made of a flame-retardant material, the outer shell extending over at least a portion of the inner liner; and
a gaiter joining the inner liner and outer shell along at least one extremity of the firefighter protective pants, the gaiter being made of an interface material having particulate-impermeable and air-permeable properties.

In some embodiments, the gaiter is permanently attached to at least one of the inner liner and the outer shell.

In some embodiments, the firefighter protective pants include a fastener arrangement attaching the gaiter to at least one of the inner liner and the outer shell.

In some embodiments, the particulate-impermeable properties of the interface material include blocking particulates having a size between about 0.1 μm to 1 μm.

In some embodiments, the air permeable properties of the interface material include an air permeability of at least about 4.5 cm³/sec/cm².

In one embodiment, such a protective interface may include sleeve wells provided at the extremities of the sleeves of a firefighter coat. The sleeve wells are preferably made of a material which is particulate-impermeable, while being air-permeable.

In another embodiment, the protective interfaces may include wristlets provided at is the extremities of the sleeves of the firefighter. The wristlets preferably include a wristlet barrier made of a material which is particulate-impermeable, while being air-permeable. Optionally, the wristlet barrier may be an extension of the corresponding sleeve well.

The protective interfaces may also include a stormband provided inside the coat of a firefighter and encircling the wearer's waist. The stormband is preferably made of a material which is particulate-impermeable, while being air-permeable.

In yet another embodiment, the protective interfaces may include gaiters provided at the lower extremities of the legs of firefighter pants. The gaiters are preferably made of a material which is particulate-impermeable, while being air-permeable.

Other features and advantages of the present invention will be better understood upon a reading of embodiments thereof with reference to the appended drawings.

### BRIEF DESCRIPTION OF THE DRAWINGS

FIG. 1 is a side elevation view of a firefighter coat including a protective interface, in accordance with an embodiment.

FIG. 2A is a side elevation view of an extremity of a sleeve of the coat of FIG. 1;

FIG. 2B is a cross-sectional view of a wristlet provided near the extremity of the sleeve, taken along the line 2B-2B, in accordance with an embodiment.

FIG. 3 is a side elevation view of a firefighter coat in an open configuration, in accordance with an embodiment.

FIG. 4 is a side elevation view of firefighter pants, in accordance with another embodiment.

FIG. 5 is a side elevation view of an extremity of the pants of FIG. 4, in accordance with an embodiment.

### DETAILED DESCRIPTION

The present description refers to protective interfaces for firefighter garments, such as coats and pants.

Firefighter Coat

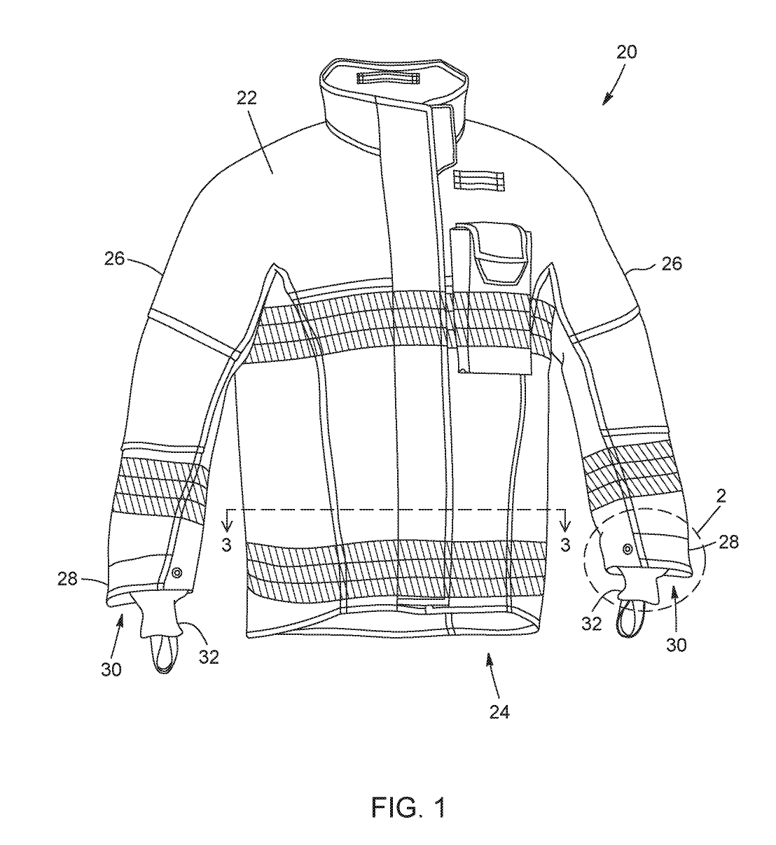

Referring to FIG. 1, there is shown a representation of a firefighter garment, embodied by firefighter protective coat 20.

The firefighter protective coat 20 includes an outer shell 22. The outer shell 22 is typically made of a flame-retardant material. The flame-retardant material can be made, for example and without being limitative, a fabric of aramid fibers (sold under the trademark NOMEX).

The firefighter protective coat 20 also includes an inner liner 24. The inner liner 24 typically includes a moisture barrier, for example made of expanded polytetra uoroethylene (ePTFE) and/or polyurethane (PU) laminated to a woven or non-woven aramid substrate, and a thermal barrier consisting of a face cloth quilted to an aramid substrate.

The inner liner 24 generally extends over at least a portion of the internal portion of the outer shell 22, and may, in some implementations, extend over the entirety of the internal portion of the outer shell 22.

The inner liner 24 is typically separable from the outer shell 22 to facilitate washing and care of both layers (i.e., the outer shell 22 and the inner liner 24). Various mechanisms to join the outer shell 22 and inner liner 24 together at the extremity of the sleeves are known in the art, such as snap fastener arrangements or hook and loop fasteners such as the ones known under the tradename VELCRO (trademark).

The firefighter protective coat 20 includes a protective interface, which may be, for example, be embodied by sleeve well(s), wristlet(s) and/or stormband(s), as it will be described in greater detail below.

In the embodiment illustrated in FIG. 1, the protective interface notably includes two sleeve wells 30 and two wristlets 32.

Broadly described, the protective interface joins the inner liner 24 and outer shell 22 along at least one extremity of the garment (i.e., the coat 20 of FIG. 1). In some embodiments, the protective interface is permanently attached to at least one of the inner liner 24 and the outer shell 22. The firefighter protective coat 20 can include a fastener arrangement (not illustrated in FIG. 1) attaching the protective interface to at least one of the inner liner 24 and the outer shell 22. Such fastener arrangement may include, for example and without being limitative, snap fastener and/or hook and loop fasteners.

The protective interface is made of an interface material having particulate-impermeable and air-permeable properties. For example, the particulate-impermeable properties of the interface material may include blocking particulates having a size between about 0.1 μm to 1 μm. The air permeable properties of the interface material may include an air permeability of at least about 4.5 cm³/sec/cm². It will be readily understood that the interface material may have other particulate-impermeable and air-permeable properties, depending on the targeted application and/or the requirement(s) to be met.

In some embodiments, the interface material is a trilaminate including, for example and without being limitative:
a membrane made of expanded polytetrafluoroethylene (ePTFE);
an aramid knit provided on a first side of the membrane; and
a reprocessed cellulose multifilament knit provided on a second side of the membrane.

### Sleeve Wells

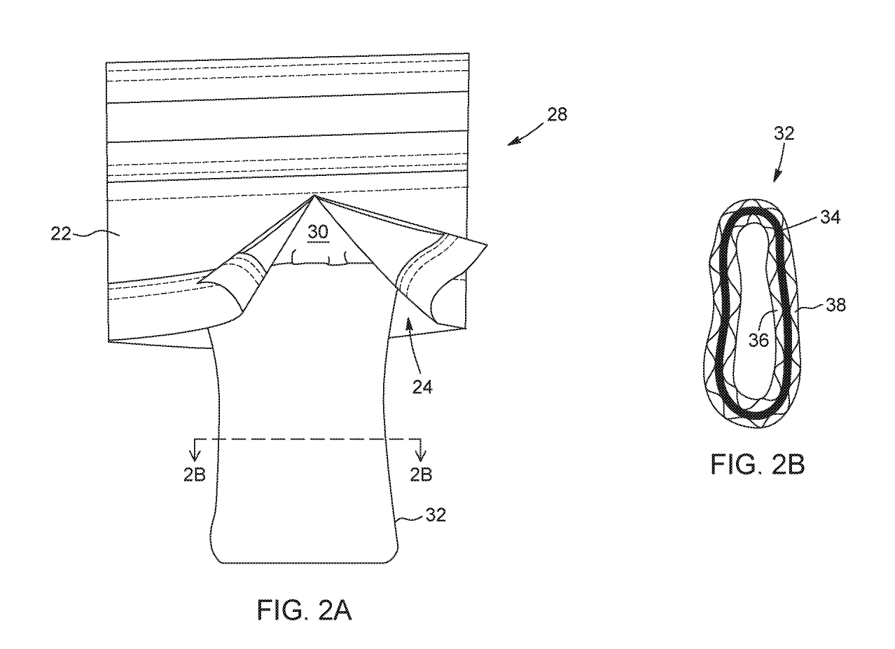

As it has been previously mentioned, the protective interface may be embodied by a sleeve well. As better illustrated in FIGS. 1 and 2A-B, the coat 20 includes sleeves 26 (e.g., two sleeves) which incorporate sleeve wells 30 on their respective lower extremities 28.

As their name entails, the sleeve wells 30 can be understood as a length of fabric folding inwardly of the extremity 28 of the sleeve 26 and forming a “well”. The sleeve wells 30 are typically physically attached to the outer shell 22 or optionally attached to the inner liner 24 of the coat 20. In other variants, the sleeve wells 30 may be either permanently attached or removably affixed to the remainder of the coat sleeves 26.

A human being involved in the activities of firefighting generates metabolic heat that must be dissipated if he/she is to maintain healthy bodily function. The principal means by which the clothed firefighter dissipates metabolic heat is by perspiring. The greatest rate of metabolic heat transfer through perspiration occurs via the mechanism of evaporative cooling wherein liquid sweat evaporates and the resulting vapor either permeates whatever layers of clothing the firefighter may be wearing or is carried away by air circulating within the garment.

Furthermore, recent literature in work-place pathology has revealed the hazards that fire-ground particulate matter poses to the health and well-being of firefighters. For example, the National Fire Protection Association, in its proposed NFPA 1971-2018, Standard on Protective Ensembles for Structural Fire Fighting and Proximity Fire Fighting envisions firefighter hoods that protect the neck and head of the firefighter not only from heat and flame but also from carcinogenic particulate matter.

In one aspect, the sleeve wells 30 should therefore prevent the ingress of particulate matter between the inner liner 24 and outer shell 22 of the coat 20, or between the inner liner 24 and the body of the firefighter. The sleeve wells 30 are also preferably made of a material optimising both the comfort and the protection of the wearer.

In some implementations, as mentioned above the sleeve wells 30 are made of a material which is particulate-impermeable, while being air-permeable. On the one hand, air-permeability may enhance evaporative cooling and thereby, firefighter comfort. On the other hand, particulate-impermeability may block carcinogenic particulate matter and other particulates potentially hazardous to the health of the firefighter.

In some embodiments, the material of the sleeve wells 30 may meet specific requirements with respect to air permeability. Preferably, the material of the sleeve wells 30 has an air permeability which is high enough so that sufficient air can circulate through the sleeve well to provide a degree of cooling to the wearer, while being low enough to block most particulates which may constitute a hazard to the firefighter's health.

In some implementations, the material of the sleeve wells 30 blocks particulates having a size between about 0.1 μm to 1 μm. In one example, and without being limitative, the above conditions may be met by a material having an air permeability of about 4.5 cm³/sec/cm² or more, when tested according to ASTM D 737.

By way of example, the material of the sleeve wells 30 may be a trilaminate including an ePTFE membrane laminated with an aramid knit on both sides.

More particularly, the material of the sleeve wells 30 may be a trilaminate consisting of an ePTFE membrane laminated with a first aramid knit on a first side of the membrane, and a second aramid knit provided on a second side of the membrane.

In another example, the material of the sleeve wells 30 may be a trilaminate consisting of an ePTFE membrane laminated with aramid knits on one side, and a reprocessed cellulose multifilament knit on the other side.

In another example, the interface material includes a meta-aramid material quilted between two aramid knits. In some embodiments, the meta-aramid material is made of material including nanofibers (e.g., Nomex® or Nano/Nomex®)

In the examples described above, the weight of the knits may be selected in view of providing a resulting permeability within the desired range which has been previously discussed. Of course, it will be readily understood that these examples are provided for illustrative purpose only, and that other material may be used without departing from the scope of the invention.

In some embodiments, the extremity 28 of the sleeve 26 is made of a two-ply material, and the sleeve well 30 is provided near the extremity of the two-ply material. In this context, a portion of the sleeve well 30 may be embedded between the two plies of the material included in the extremity 28 of the sleeve 26.

Still referring to FIGS. 1 and 2A-B, the firefighter coat 20 further includes wristlets 32, also known as “wristers”, projecting from the lower extremities 28 of the sleeves 26 and designed to fit closely over and/or around at least a portion of the wrists and base of the hands of the wearer. The wristlets 32 are usually made of extensible, knit fabric. The wristlets 32 may be shaped, for example and without being limitative, as a cylindrical band only or may include an eyelet to allow the thumb of the wearer through, or a material loop designed to be interlaced between the thumb and the index finger of the wearer to keep the wristlet 32 from sliding out of place.

The type of knit fabric typically used in the fabrication of the wristlets 32 of the firefighter coat 20 could potentially allow hazardous fire-ground particulates to come into contact with the skin of the firefighter.

Referring to FIG. 2B, in accordance with some implementations, each wristlet 32 may therefore include a wristlet barrier 34 made of a material which is particulate-impermeable. Preferably, the material of the wristlet barrier 34 is also air-permeable. In some variants, the wristlet barrier 34 may be made of the same material as the sleeve wells 30, and, in some implementations, may be integral to the sleeve wells, that is, the wristlet barrier 34 is an extension of the same piece of fabric making up the sleeve well 30. Preferably, the wristlet barrier 34 extends along the entire length of the wristlet or a substantial length forward of the sleeve well. In the illustrated embodiment of FIG. 2B, the wristlet barrier 34 is sandwiched between an inner and an outer knit layer 36 and 38. Suitable stitching, sewing or other known attachment means may be used to assemble together the wristlet barrier 34, the inner knit 36 and the outer knit 38 of the wristlet 32 and the connection of the wristlet 32 to the sleeve well 30.

### Storm Band

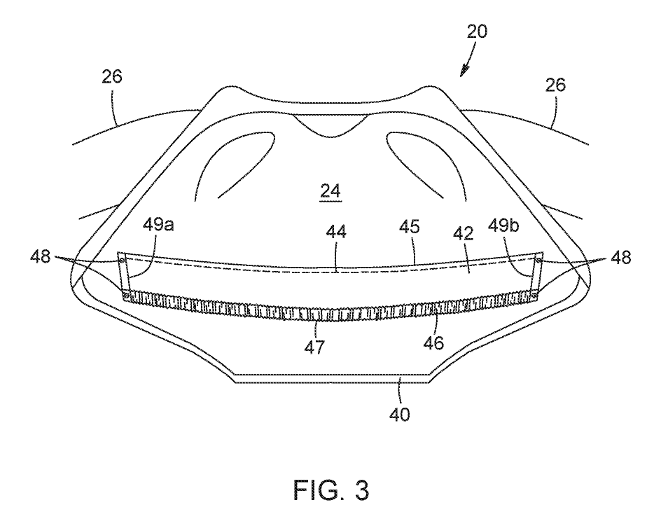

Now referring to FIG. 3, there is shown a firefighter coat 20 in an open configuration.

The firefighter coat 20 includes a storm band 42, which can be provided inside the coat 20, preferably at waist height (i.e., the stormband 42 is preferably positioned near the user's waist when the firefighter coat 20 is worn by the user). The stormband 42 provides a barrier between the inner liner 24 of the coat 20 and the midriff of the wearer. Preferably, the stormband 42 is positioned such that it encircles the body of the wearer along the upper portion of his protective pants when the firefighter is in full gear, leaving no unprotected passage for potentially dangerous particulate matter to penetrate under the firefighter garments from the bottom end 40 of the firefighter coat 20.

The stormband 42 may be affixed to the inner liner 24 of the coat 20 through different mechanisms, such as seams, snap fastener arrangements or hook and loop fasteners. In the illustrated configuration of FIG. 3, the stormband 42 is affixed through a seam or seams 44 extending along the upper edge 45 of the stormband. An elastic strip 46 is provided along the lower edge 47 of the stormband 42. Preferably, an attachment mechanism 48 is provided at the opposite sides 49a, 49b of the stormband 42, such as a snap fastener arrangement, hook and loop fasteners, a drawstring arrangement, or other attachment mechanisms. Preferably, the stormband 42 is configured such that its sides 49a, 49b overlap when the coat is properly fastened on the firefighter, so that it completely encircles the firefighter and block any potential particulate ingress path near his/her waist.

The stormband 42 is made of a material which is particulate-impermeable, while being air-permeable, optimising both the comfort and the security of the wearer. Preferably, the material of the stormband 42 has an air permeability which is high enough so that sufficient air can circulate through the stormband 42 to provide a degree of cooling to the wearer, while being low enough to block most particulates which may constitute a hazard to the firefighter's health. In some variations, the material of the stormband 42 blocks particulates having a size between about 0.1 μm to 1 μm. In one example, the above conditions may be met by a material having an air permeability of about 4.5 cm³/sec/cm² or more, when tested according to ASTM D 737. By way of example, the material of the stormband 42 may be a trilaminate made of an ePTFE membrane laminated with an aramid knit on both sides.

In another example, the material of the stormband 42 may be a trilaminate including an ePTFE membrane laminated with aramid knits on one side, and a reprocessed cellulose multifilament knit on the other side.

In the two examples presented above, the weight of the knits may be selected in view of providing a resulting permeability within the desired range discussed above. Of course, it will be readily understood that these examples are provided for illustrative purpose only and that other material may be used without departing from the scope of the invention.

In some embodiments, the firefighter protective coat 20 includes more than one protective interfaces. For example, in some embodiments, the firefighter coat 20 includes two sleeve wells 30, two wristlets 32 and one stormband 42, which may all be similar to the ones which have been described above.

The different embodiments of the firefighter coat 20 described in the current description can be compliant with the National Fire Protection Association Standard on Protective Ensembles for Structural Fire Fighting and Proximity Fire Fighting.

### Firefighter Pants

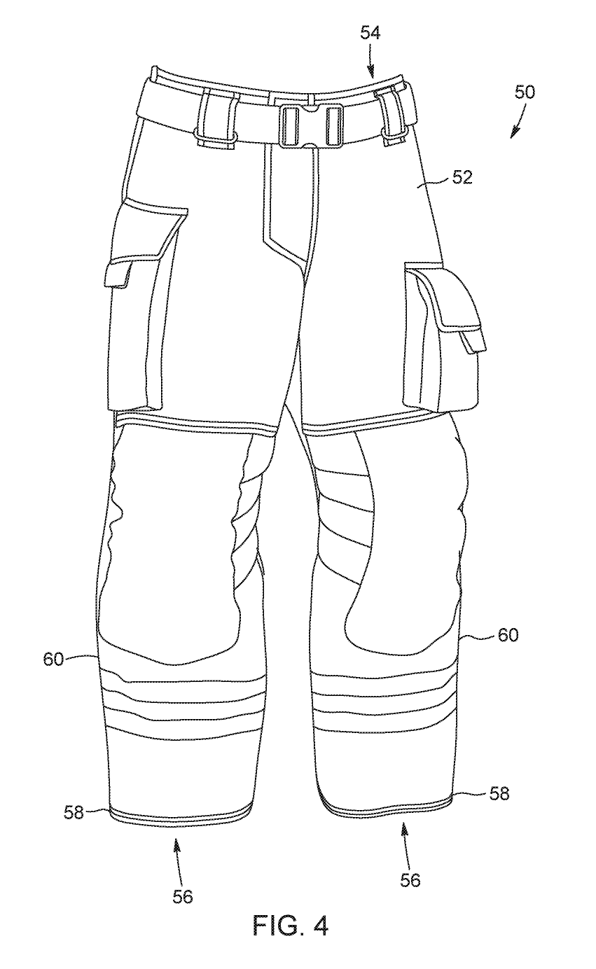

Referring to FIG. 4, there is shown a representation of firefighter pants 50. As for the firefighter coat 20 described above, the firefighter pants 50 typically include a pant outer protective shell 52 made of a fire-resistant material such as a fabric of aramid fibers (sold under the trademark NOMEX), and a pant inner liner 54. The inner liner 54 typically includes a moisture barrier, for example made of expanded polytetrafluoroethylene (ePTFE) and/or polyurethane (PU) laminated to a woven or non-woven aramid substrate, and a thermal barrier consisting a face cloth quilted to an aramid substrate. The inner liner 54 is typically separable from the outer shell 52 to facilitate washing and care of both layers, in a similar fashion to the inner liner and outer shell of the firefighter protective coat which has been previously described.

### Gaiters

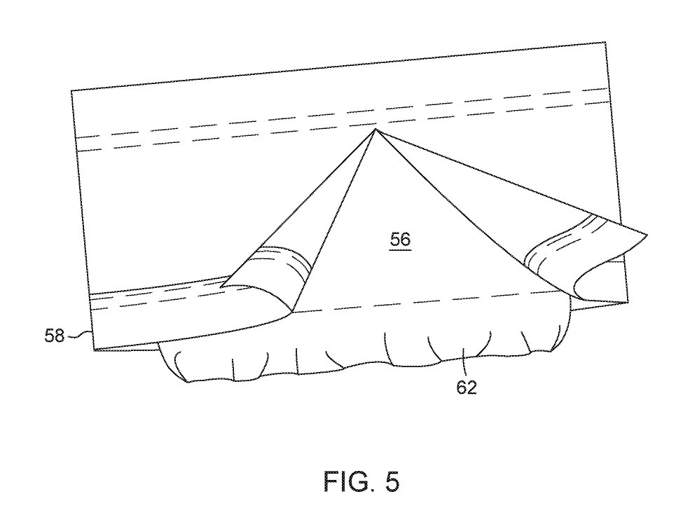

Referring to both FIGS. 4 and 5, the firefighter pants 50 include gaiters 56 on the lower extremities 58 of the pant legs 60. Preferably, the gaiters 56 firmly and snuggly encircle the boot of the firefighter with the objective of preventing the ingress of fire-ground particulate matter between the firefighter's boot and the pant liner 54, and consequently between the pant liner 54 and the body of the firefighter. Such gaiters 56 may incorporate an annular elastic 62 in their distal end that circumferentially grips the shaft of the boot (or a portion thereof).

In some embodiments, the gaiter 56 is attached permanently to the outer shell 52 of the pant leg 60, whereas in other variants the gaiter 56 is attached permanently to the pant inner liner 54. In other embodiments, the gaiters 56 may be removably affixed to either de outer shell 52 or the inner liner 54 of the pants 50,

Similarly to the sleeve wells described above, the pant gaiters 56 are made of a material which particulate-impermeable, while being air-permeable, to optimise both the comfort and the security of the wearer. Preferably, the material of the pant gaiters 56 has an air permeability which is high enough so that sufficient air can circulate through the pant gaiters 56 to provide a degree of cooling to the wearer, while being low enough to block most particulates which may constitute a hazard to the firefighter's health. In some variations, the material of the pant gaiters 56 blocks particulates having a size between about 0.1 μm to 1 μm. In one example, the above conditions may be met by a material having an air permeability of about 4.5 cm³/sec/cm² or more, when tested according to ASTM D 737. By way of example, the material of the pant gaiters 56 may be a trilaminate consisting of an ePTFE membrane laminated with an aramid knit on both sides.

In another example, the material of the pant gaiters may be a trilaminate consisting of an ePTFE membrane laminated with aramid knits on one side, and a reprocessed cellulose multifilament knit on the other side.

In the two examples described above, the weight of the knits may be selected in view of providing a resulting permeability within the desired range discussed above. Of course, it will be readily understood that these examples are provided for illustrative purpose only and that other material may be used without departing from the scope of the invention.

The different embodiments of the firefighter pants 50 described in the current description can be compliant with the National Fire Protection Association Standard on Protective Ensembles for Structural Fire Fighting and Proximity Fire Fighting.

Of course, numerous modification could be made to the embodiments above without departing from the scope of the present invention.

1. A firefighter protective garment comprising:
an inner liner;
an outer shell made of a flame-retardant material, the outer shell extending over at least a portion of the inner liner; and
a protective interface joining the inner liner and outer shell along at least one extremity of the garment, the protective interface being made of an interface material having particulate-impermeable and air-permeable properties.

2. The firefighter protective garment of claim 1, wherein the protective interface is permanently attached to at least one of the inner liner and the outer shell.

3. The firefighter protective garment of claim 1, comprising a fastener arrangement attaching the protective interface to at least one of the inner liner and the outer shell.

4. The firefighter protective garment of claim 1, wherein the particulate-impermeable properties of the interface material comprise blocking particulates having a size between about 0.1 μm to 1 μm.

5. The firefighter protective garment of claim 1, wherein the air permeable properties of the interface material comprise an air permeability of at least about 4.5 cm³/sec/cm².

6. The firefighter protective garment of claim 1, wherein the interface material is a trilaminate comprising:
a membrane made of expanded polytetrafluoroethylene (ePTFE);
an aramid knit provided on a first side of the membrane; and
a second aramid knit provided on a second side of the membrane.

7. The firefighter protective garment of claim 1, wherein the interface material is a trilaminate comprising:
a membrane made of expanded polytetrafluoroethylene (ePTFE);
an aramid knit provided on a first side of the membrane; and
a reprocessed cellulose multifilament knit provided on a second side of the membrane.

8. The firefighter protective garment of claim 1, wherein the interface material comprises a meta-aramid material quilted between two aramid knits.

9. A firefighter protective coat comprising:
an inner liner;
an outer shell made of a flame-retardant material, the outer shell extending over at least a portion of the inner liner; and
a protective interface joining the inner liner and outer shell along at least one extremity of the firefighter protective coat, the protective interface being made of an interface material having particulate-impermeable and air-permeable properties.

10. The firefighter protective coat of claim 9, wherein the protective interface is permanently attached to at least one of the inner liner and the outer shell.

11. The firefighter protective coat of claim 9, comprising a fastener arrangement attaching the protective interface to at least one of the inner liner and the outer shell.

12. The firefighter protective coat of claim 9, wherein the particulate-impermeable properties of the interface material comprise blocking particulates having a size between about 0.1 μm to 1 μm.

13. The firefighter protective coat of claim 9, wherein the air permeable properties of the interface material comprise an air permeability of at least about 4.5 cm³/sec/cm².

14. The firefighter protective coat of clai herein the protective interface is a sleeve well.

15. The firefighter protective coat of claim 9, wherein the protective interface is a wristlet.

16. The firefighter protective coat of claim 9, wherein the protective interface is a stormband.

17. Firefighter protective pants comprising:
an inner liner:
an outer shell made of a flame-retardant material, the outer shell extending over at least a portion of the inner liner; and
a gaiter joining the inner liner and outer shell along at least one extremity of the firefighter protective pants, the gaiter being made of an interface material having particulate-impermeable and air-permeable properties.

18. The firefighter protective pants of claim 17, wherein the gaiter is permanently attached to at least one of the inner liner and the outer shell.

19. The firefighter protective pants of claim 17, comprising a fastener arrangement attaching the gaiter to at least one of the inner liner and the outer shell.

20. The firefighter protective pants of claim 17, wherein the particulate-impermeable properties of the interface material comprise blocking particulates having a size between about 0.1 μm to 1 μm.

21. The firefighter protective pants of claim 17, wherein the air permeable properties of the interface material comprise an air permeability of at least about 4.5 cm³/sec/cm².
